(19) United States
(12) Patent Application Publication
(10) Pub. No.: US 2017/0358860 A1
(43) Pub. Date: Dec. 14, 2017

(54) ANTENNA DEVICE AND WIRELESS DEVICE

(71) Applicant: Kabushiki Kaisha Toshiba, Tokyo (JP)

(72) Inventor: Takafumi OHISHI, Yokohama Kanagawa (JP)

(21) Appl. No.: 15/690,045

(22) Filed: Aug. 29, 2017

Related U.S. Application Data
(63) Continuation of application No. PCT/JP2015/068654, filed on Jun. 29, 2015.

(51) Int. Cl. H01Q 7/00; H01Q 9/16

(52) U.S. Cl. CPC H01Q 7/005; H01Q 9/16; H01Q 7/00

(57) ABSTRACT

An antenna device includes a substrate; a first linear conductive element that is disposed on the substrate so as to have a loop shape line-symmetric with respect to a first straight line and a second straight line that is orthogonal to the first straight line, the first linear conductive element having a first electrical length between intersections of the first linear conductive element and the second straight line that is an integer multiple of a wavelength at a resonance frequency; and a second linear conductive element that is disposed on the substrate and is substantially parallel to the second straight line, the second linear conductive element having a second electrical length that is a half wavelength of the wavelength at the resonance frequency.

### CROSS-REFERENCE TO RELATED APPLICATIONS

This application is a continuation of PCT international application Ser. No. PCT/JP2015/068654 filed on Jun. 29, 2015, which designates the United States; the entire contents of which are incorporated herein by reference.

### FIELD

The present invention relates to an antenna device and a wireless device.

### BACKGROUND

Conventionally, an antenna in which a loop-shaped antenna element is disposed at a short distance away from a base plate surface has been known. The directivity of the antenna such as the above becomes perpendicular to the base plate surface, by making the circumference length of the loop-shaped antenna element to about a wavelength or less.

However, in the conventional antenna, the directivity parallel to the base plate surface has not been taken into consideration, and thus, there is a possibility for the antenna not being able to communicate with a wireless device that is disposed parallel to the base plate surface. In this manner, with the conventional antenna, communication is limited in the direction parallel to the base plate surface.

### BRIEF DESCRIPTION OF DRAWINGS

FIG. 1 is a perspective view illustrating an antenna device according to a first embodiment.

FIG. 2 is a top view illustrating the antenna device according to the first embodiment.

FIG. 3 is a diagram illustrating radiation characteristics of the antenna device according to the first embodiment.

FIG. 4 is a diagram illustrating the radiation characteristics of the antenna device according to the first embodiment.

FIG. 5 is a perspective view illustrating an antenna device according to a second embodiment.

FIG. 6 is a top view illustrating the antenna device according to the second embodiment.

FIG. 7 is a diagram illustrating radiation characteristics of the antenna device according to the second embodiment.

FIG. 8 is a diagram illustrating the radiation characteristics of the antenna device according to the second embodiment.

FIG. 9 is an explanatory diagram of the radiation characteristics of the antenna device according to the second embodiment.

FIG. 10 is an explanatory diagram of the radiation characteristics of the antenna device according to the second embodiment.

FIG. 11 is a diagram illustrating the radiation characteristics of the antenna device according to the second embodiment.

FIG. 12 is a diagram illustrating the radiation characteristics of the antenna device according to the second embodiment.

FIG. 13 is a diagram illustrating an antenna device according to a first modification of the second embodiment.

FIG. 14 is a diagram illustrating an antenna device according to a second modification of the second embodiment.

FIG. 15 is a top view illustrating an antenna device according to a third embodiment.

FIG. 16 is a diagram illustrating VSWR characteristics of the antenna device according to the third embodiment.

FIG. 17 is an explanatory diagram of the VSWR characteristics of the antenna device according to the third embodiment.

FIG. 18 is a diagram illustrating an antenna device according to a third modification of the third embodiment.

FIG. 19 is a diagram illustrating an antenna device according to a fourth modification of the third embodiment.

FIG. 20 is a diagram illustrating an antenna device according to a fifth modification of the third embodiment.

FIG. 21 is a diagram illustrating a wireless device according to a fourth embodiment.

FIG. 22 is a diagram illustrating the wireless device according to the fourth embodiment.

FIG. 23 is a diagram illustrating a wireless device according to a sixth modification of the fourth embodiment.

FIG. 24 is a diagram illustrating a wireless device according to a seventh modification of the fourth embodiment.

### DESCRIPTION OF EMBODIMENTS

According to an embodiment, an antenna device includes a substrate, a first linear conductive element and a second linear conductive element. The first linear conductive element is disposed on the substrate so as to have a loop shape line-symmetric with respect to a first straight line and a second straight line that is orthogonal to the first straight line, the first linear conductive element having a first electrical length between intersections of the first linear conductive element and the second straight line that is an integer multiple of a wavelength at a resonance frequency. The second linear conductive element is disposed on the substrate and is substantially parallel to the second straight line, first a second electrical length that is a half wavelength of the wavelength at the resonance frequency.

### First Embodiment

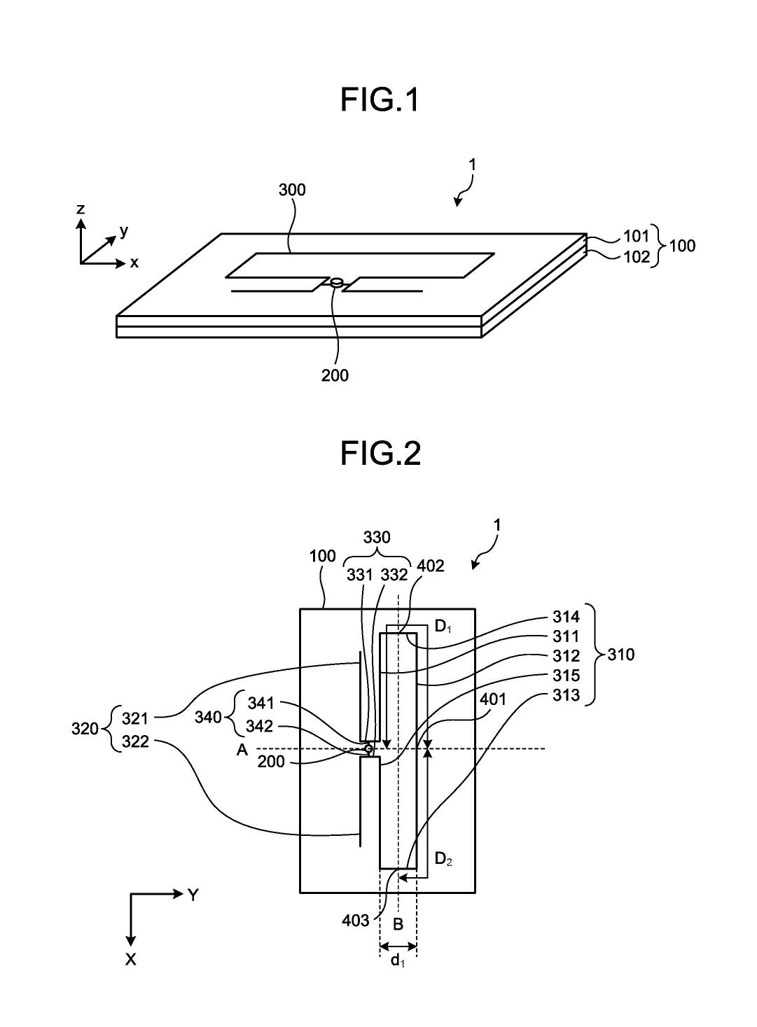

FIG. 1 is a perspective view illustrating a configuration of an antenna device 1 according to a first embodiment. To make the explanation easier to understand,

FIG. 1 includes a three-dimensional orthogonal coordinate system including a Z-axis the upward direction of which in the drawing is the positive direction, and the downward direction of which in the drawing is the negative direction. Such orthogonal coordinate system may also be illustrated in other drawings used in the following description.

The antenna device 1 includes a substrate 100, a power feeding point 200, and a linear conductive element 300. The substrate 100 is a multilayer substrate including a dielectric layer 101 having a rectangular shape and a ground layer 102. For example, the ground layer 102 is made of a metal layer such as copper and gold.

The linear conductive element 300 is an antenna element disposed on the dielectric layer 101 of the substrate 100. The power feeding point 200 is provided on the linear conductive element 300. The linear conductive element 300 transmits a signal that is received from a wireless unit, which is not illustrated, via the power feeding point 200. Alternatively, the linear conductive element 300 outputs a signal received via the power feeding point 200 to the wireless unit.

Next, the linear conductive element 300 will be described in detail with reference to FIG. 2. FIG. 2 is a top view illustrating the antenna device 1 according to the present embodiment. The linear conductive element 300 illustrated in FIG. 2 includes a first linear conductive element 310, a second linear conductive element 320, a third linear conductive element 330, and a fourth linear conductive element 340.

The first linear conductive element 310 is a conductive element having a loop shape that is disposed so as to be in line symmetry with respect to a first straight line A and a second straight line B that is orthogonal to the first straight line A. In this example, the first straight line A and the second straight line B are virtual straight lines parallel to the substrate 100. In other words, the substrate 100 has a plane parallel to a plane including the first straight line A and the second straight line B, and the first linear conductive element 310 is provided on the plane such as the above.

The first linear conductive element 310 includes first to fifth linear elements 311 to 315. The first linear element 311 and the fifth linear element 315 are disposed on the same straight line. In other words, the first linear element 311 and the fifth linear element 315 connect the power feeding point 200 and the center portion of the straight linear elements, via the third linear conductive element 330 and the fourth linear conductive element 340. Moreover, the first and the fifth linear elements 311 and 315, and the second linear element 312 are disposed parallel to one another.

In other words, the first and the fifth linear elements 311 and 315, and the second linear element 312 are parallel to the second straight line B. Moreover, a part of the first linear element 311 and the second linear element 312 are line-symmetric with respect to the second straight line B, and a part of the fifth linear element 315 and the second linear element 312 are line-symmetric with respect to the second straight line B. Furthermore, an electrical length d₁ between the first linear element 311 and the second linear element 312, and between the second linear element 312 and the fifth linear element 315 is shorter than an integer multiple of a half wavelength of the resonance frequency f (d₁<mλ/2, m: natural number).

An end of the fourth linear element 314 is connected to an end of the first linear element 311, and the other end of the fourth linear element 314 is connected to an end of the second linear element 312. Moreover, an end of the third linear element 313 is connected to an end of the fifth linear element 315, and the other end of the third linear element 313 is connected to the other end of the second linear element 312. The third linear element 313 and the fourth linear element 314 are line-symmetric with respect to the first straight line A, and are parallel to the first straight line A. As illustrated in FIG. 2, similar to the electrical length d₁ between the first linear element 311 and the second linear element 312, an electrical length of the third linear element 313 and the fourth linear element 314 is shorter than an integer multiple of a half wavelength of the resonance frequency f.

The first linear conductive element 310 is a conductive element having a loop shape line-symmetric with respect to the first straight line A and the second straight line B. The first linear conductive element 310 operates as a loop antenna, which will be described below, by connecting to the power feeding point 200 at the intersection between the first linear conductive element 310 and the first straight line A, via the third linear conductive element 330 and the fourth linear conductive element 340.

In the first linear conductive element 310, an electrical length between the intersections of the first linear conductive element 310 and the first straight line A is an integer multiple of the wavelength λ at the resonance frequency f. In other words, an electrical length D₁ of the first linear conductive element 310, from the power feeding point 200 to a second intersection (hereinafter, referred to as an intersection 401) between the first linear conductive element 310 and the first straight line A is set to the length satisfying 2πD₁/λ+π=(2n−1)×π.

Consequently, the electrical length D₁ of the first linear conductive element 310 is an integer multiple of the wavelength λ at the resonance frequency f of the first linear conductive element 310 (D₁=nλ, n: natural number). Because the first linear conductive element 310 has a loop shape line-symmetric with respect to the first straight line A, the circumference length D of the first linear conductive element 310 is twice the electrical length D₁ of the first linear conductive element 310 (D=2D₁=2nλ).

Furthermore, in the first linear conductive element 310, an electrical length between the intersection of the first linear conductive element 310 with the first straight line A, and the intersection of the first linear conductive element 310 with the second straight line B, is an integer multiple of a half wavelength of the resonance frequency f. In other words, an electrical length D₂ from the intersection 401 to a second intersection (hereinafter, referred to as an intersection 403) between the first linear conductive element 310 and the second straight line B is an integer multiple of a half wavelength (D₂=nλ/2).

As described above, the first linear conductive element 310 is line-symmetric with respect to the first straight line A, and also line-symmetric with respect to the second straight line B. Thus, the distance from the intersection 401 to an intersection 402 of the first linear conductive element 310 becomes the same as the electrical length D₂. Moreover, the distance from the power feeding point 200 to the intersection 403 between the first linear conductive element 310 and the second straight line B, and the distance from the intersection 401 to a first intersection (hereinafter, referred to as the intersection 402) between the first linear conductive element 310 and the second straight lint B are an integer multiple of a half wavelength (D₂=nλ/2), which is the same as the electrical length D₂.

The second linear conductive element 320 includes a sixth linear element 321 and a seventh linear element 322. The sixth linear element 321 and the seventh linear element 322 are disposed on the same straight line. Moreover, the sixth linear element 321 and the seventh linear element 322 are disposed parallel to the second straight line B.

In the example illustrated in FIG. 2, the second linear conductive element 320 is disposed on the substrate 100, and outside of the loop shape of the first linear conductive element 310. The electrical length of the second linear conductive element 320 is a half wavelength of the resonance frequency f.

The third linear conductive element 330 includes an eighth linear element 331 and a ninth linear element 332. An end of the eighth linear element 331 is connected to an end of the sixth linear element 321, and the other end of the eighth linear element 331 is connected to the other end of the first linear element 311. An end of the ninth linear element 332 is connected to an end of the seventh linear element 322, and the other end of the ninth linear element 332 is connected to the other end of the fifth linear element 315. The third linear conductive element 330 electrically connects between the first linear conductive element 310 and the second linear conductive element 320.

The fourth linear conductive element 340 includes a tenth linear element 341 and an eleventh linear element 342. An end of the tenth linear element 341 is connected to the eighth linear element 331, and the other end of the tenth linear element 341 is connected to the power feeding point 200. An end of the eleventh linear element 342 is connected to the ninth linear element 332, and the other end of the eleventh linear element 342 is connected to the power feeding point 200.

Consequently, the first linear conductive element 310 is connected to the power feeding point 200, via the third linear conductive element 330 and the fourth linear conductive element 340. Thus, the first linear conductive element 310 operates as a loop antenna. Moreover, the second linear conductive element 320 is connected to the power feeding point 200, via the third linear conductive element 330 and the fourth linear conductive element 340. Thus, the second linear conductive element 320 operates as a dipole antenna.

Next, the operating principle of the antenna device 1 will be described in detail with reference to FIG. 2. The electric current input via the power feeding point 200 flows to the first linear conductive element 310. Because the electrical length D₁ from the power feeding point 200 to the intersection 401 of the first linear conductive element 310 is an integer multiple of the wavelength λ at the resonance frequency f, the direction of the electric current that flows through the power feeding point 200 and the direction of the electric current that flows through the intersection 401 are opposite from each other in FIG. 2. In other words, the phase of the electric current that flows through the first and the fifth linear elements 311 and 315, and the phase of the electric current that flows through the second linear element 312 are opposite from each other in FIG. 2.

Thus, the transmission of radio waves caused by the electric current that flows through the first and the fifth linear elements 311 and 315, and the transmission of radio waves caused by the electric current that flows through the second linear element 312 cancel out with each other. Consequently, in the radiation pattern of the first linear conductive element 310, the radio waves are prevented from transmitting in the direction where the linear conductive element 300 is arranged (Z-axis positive direction in FIGS. 1 and 2) from the substrate 100, and the radio waves are properly transmitted in the direction parallel to the substrate 100 (X-axis direction in FIGS. 1 and 2).

Moreover, the electric current input via the power feeding point 200 flows to the second linear conductive element 320. The electrical length of the second linear conductive element 320 is a half wavelength at the resonance frequency f. Thus, in the radiation pattern of the second linear conductive element 320, the radio waves can be properly transmitted in the direction where the linear conductive element 300 is arranged (Z-axis positive direction in FIG. 2) from the substrate 100, and in the direction perpendicular to the second linear conductive element 320 (Y-axis direction in FIG. 2).

Consequently, the radiation pattern of the antenna device 1 is a combination of the radiation pattern of the first linear conductive element 310 and the radiation pattern of the second linear conductive element 320. Hence, the radio waves can be properly transmitted in the direction where the linear conductive element 300 is arranged (Z-axis positive direction in FIG. 2) from the substrate 100, and in the direction parallel to the substrate 100 (X-axis direction and Y-axis direction in FIG. 2).

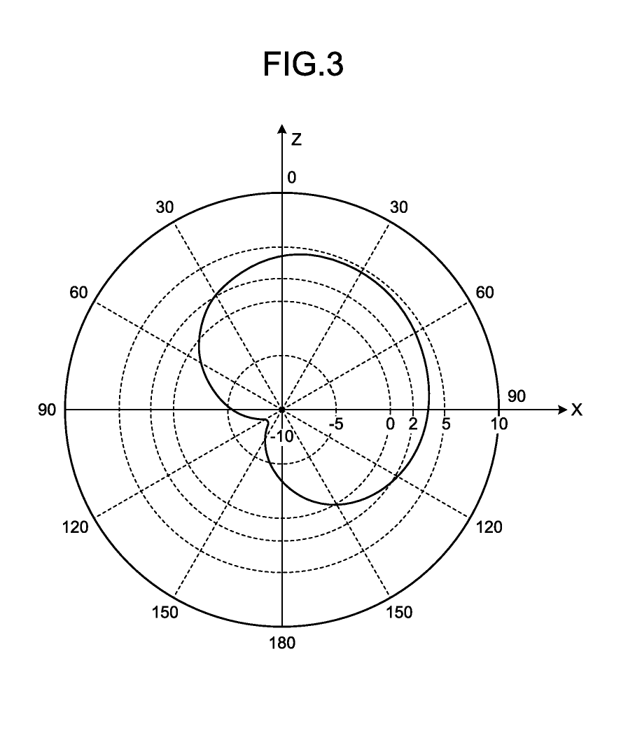

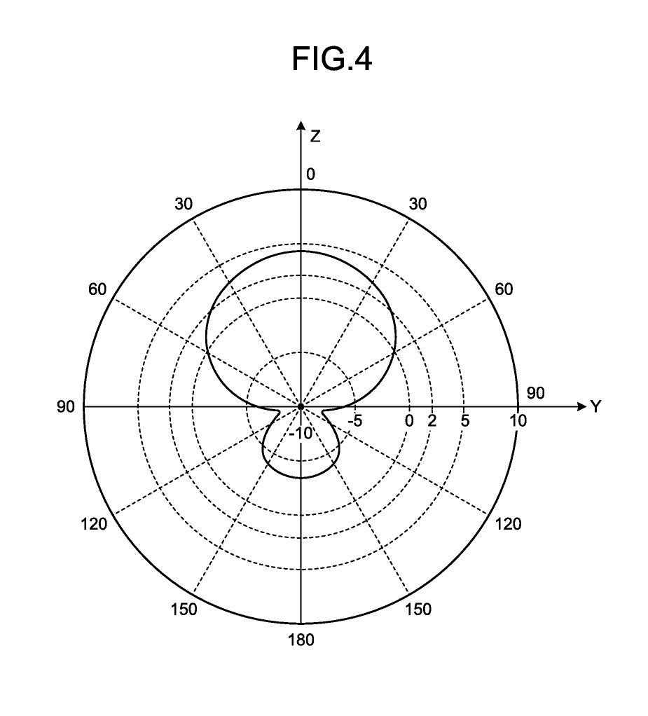

FIG. 3 and FIG. 4 are diagrams each illustrating radiation characteristics of the antenna device 1 according to the present embodiment. FIG. 3 is a diagram illustrating the radiation characteristics of the antenna device 1 according to the present embodiment in an X-Z plane, and FIG. 4 is a diagram illustrating the radiation characteristics of the antenna device 1 in a Y-Z plane.

As illustrated in FIG. 3, in the X-Z plane, a range where the antenna device 1 gains 2 dBi or more is a range from approximately +130 degrees to approximately −38 degrees. As illustrated in FIG. 4, in the Y-Z plane, a range where the antenna device 1 gains 2 dBi or more is a range of approximately ±45 degrees. In this manner, with the antenna device 1 according to the present embodiment, the radio waves can be properly transmitted in the X-axis direction and the Y-axis direction.

In this manner, the antenna device 1 according to the present embodiment includes the first linear conductive element 310 and the second linear conductive element 320. The first linear conductive element 310 is formed in a loop shape that is line-symmetric with respect to the first straight line A and the second straight line B, and the electrical length D₁ of the first linear conductive element 310 is an integer multiple of a wavelength. Moreover, the second linear conductive element 320 is disposed in parallel with respect to the second straight line B, and the electrical length of the second linear conductive element 320 is a half wavelength. In this manner, it is possible to increase the amount of radio waves to be transmitted in the direction where the first linear conductive element 310 is arranged from the substrate 100, and in the direction parallel to the substrate 100. Consequently, for example, the antenna device 1 can communicate with a wireless device that is disposed in the direction parallel to the substrate 100. Hence, it is possible to improve communication flexibility.

As described above, the antenna device 1 according to the present embodiment can increase the amount of radio waves to be transmitted in the direction parallel to the substrate 100. Thus, for example, the antenna device 1 is suitable for what is called on-body communication that is communication performed between wireless devices worn on human bodies, or for communication performed between wireless devices disposed on the surface of a structure such as a wall.

### Second Embodiment

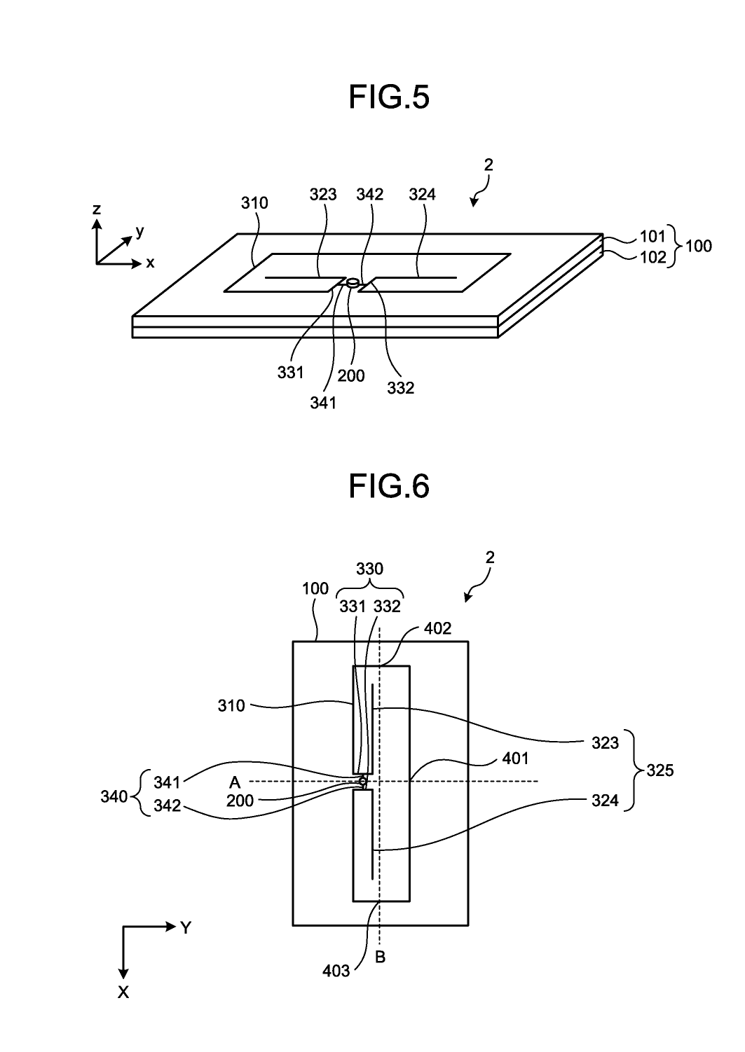

FIG. 5 is a perspective view illustrating a configuration of an antenna device 2 according to a second embodiment. FIG. 6 is a top view illustrating the configuration of the antenna device 2 according to the second embodiment. The antenna device 2 according to the present embodiment has the same configuration as that of the antenna device 1 illustrated in FIG. 1, except the configuration of a second linear conductive element 325.

The second linear conductive element 325 of the antenna device 2 includes a sixth linear element 323 and a seventh linear element 324. The sixth linear element 323 and the seventh linear element 324 are disposed on the same straight line. Moreover, the sixth linear element 323 and the seventh linear element 324 are disposed parallel to the second straight line B.

In the example illustrated in FIG. 6, the second linear conductive element 325 is disposed on the substrate 100 and inside of the loop shape of the first linear conductive element 310. It is preferable that the second linear conductive element 325 is disposed between the second straight line B and the first and the fifth linear elements 311 and 315. The electrical length of the second linear conductive element 325 is a half wavelength of the resonance frequency f.

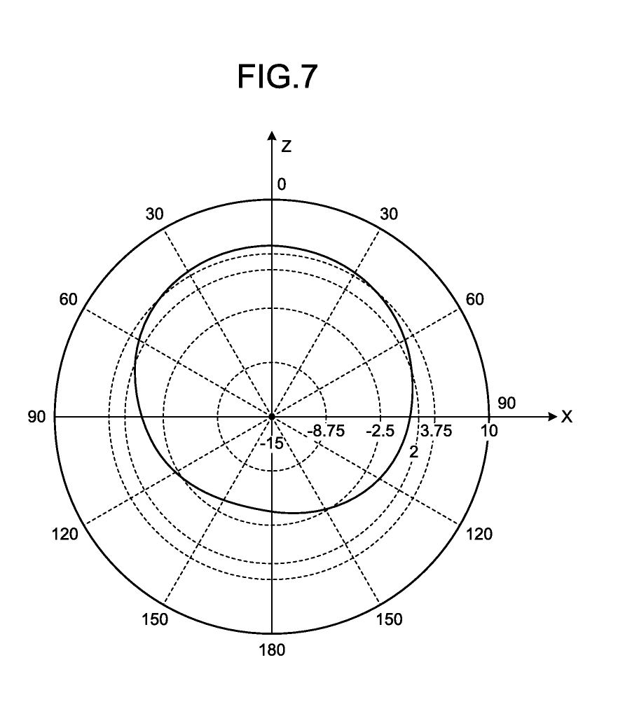

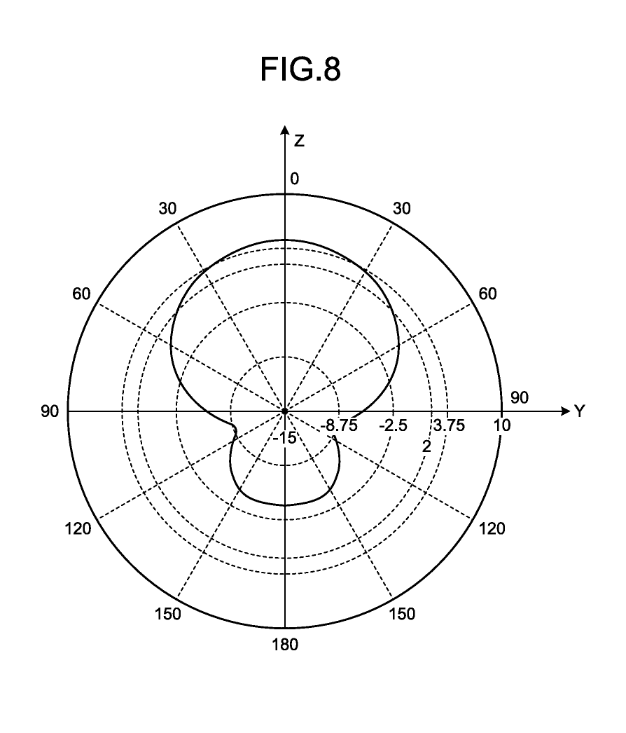

FIGS. 7 and 8 are diagrams each illustrating the radiation characteristics of the antenna device 2 according to the present embodiment. FIG. 7 is a diagram illustrating the radiation characteristics of the antenna device 2 according to the present embodiment in the X-Z plane, and FIG. 8 is a diagram illustrating the radiation characteristics of the antenna device 2 in the Y-Z plane.

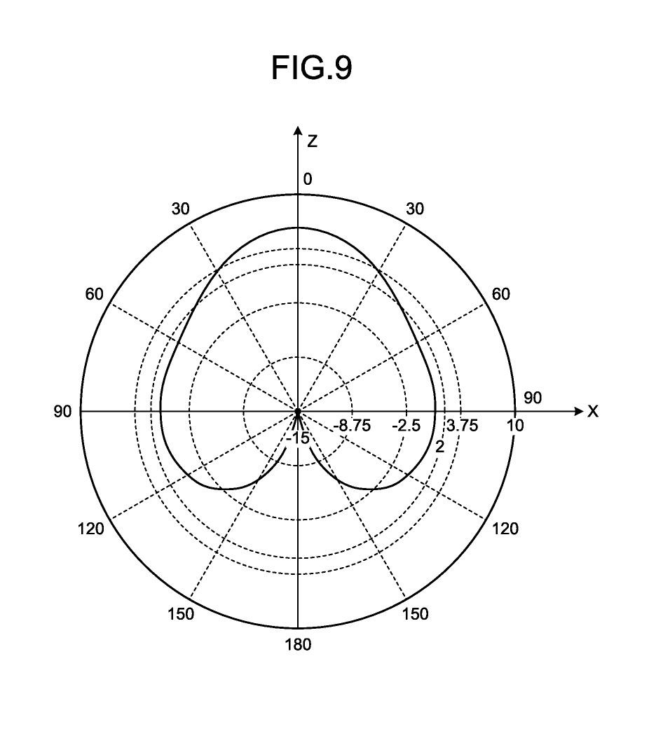

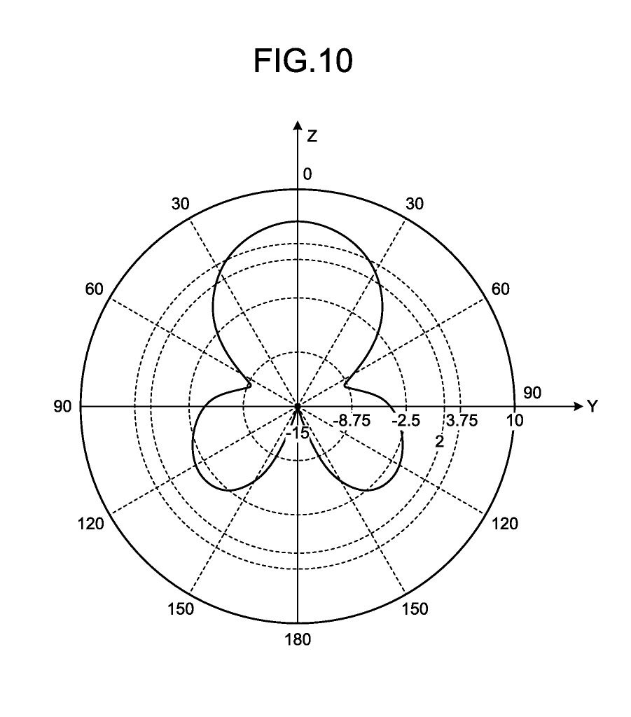

FIGS. 9 and 10 are explanatory diagrams of the radiation characteristics of the antenna device 2 according to the present embodiment. FIGS. 9 and 10 are diagrams each illustrating the radiation characteristics of the antenna device that has a loop shape and the circumference length of which is an integer multiple of a wavelength. In other words, FIGS. 9 and 10 are diagrams each illustrating the radiation characteristics of the antenna device 2 of the first linear conductive element 310 the electrical length of which corresponding to the electrical length D₁ is an integer multiple of a half wavelength. FIG. 9 is a diagram illustrating the radiation characteristics of the antenna device such as above in the X-Z plane, and FIG. 10 is a diagram illustrating the radiation characteristics of the antenna device such as above in the Y-Z plane.

As illustrated in FIG. 7 and FIG. 8, the antenna device 2 according to the present embodiment has the radiation characteristics capable of properly transmitting the radio waves in the X-axis direction and the Y-axis direction.

On the other hand, in the antenna device illustrated in FIG. 9 and FIG. 10, the electrical length corresponding to the electrical length D₁ of the first linear conductive element 310 is an integer multiple of a half wavelength. Thus, the phase of the electric current that flows through the first and the fifth linear elements 311 and 315, and the phase of the electric current that flows through the second linear element 312 of the first linear conductive element 310 are the same. Consequently, the transmission of radio waves caused by the electric current that flows through the first and the fifth linear elements 311 and 315 of the first linear conductive element 310, and the transmission of radio waves caused by the electric current that flows through the second linear element 312 strengthen each other. Hence, as illustrated in FIG. 9 and FIG. 10, in the radiation characteristics of the antenna device such as the above, the radio waves are properly transmitted in the Z-axis positive direction, but the radio waves are prevented from transmitting in the X-axis direction and the Y-axis direction.

In the radiation characteristics of the antenna device 2 of the present embodiment illustrated in FIG. 7 and FIG. 8, the transmission of radio waves in the direction parallel to the substrate 100 (X-axis direction and Y-axis direction) is improved compared with that in FIG. 9 and FIG. 10. When comparing FIG. 7 with FIG. 9, the range where the antenna device gains 2 dBi or more in FIG. 9 is a range of ±44.4 degrees, but the range where the antenna device 2 gains 2 dBi or more in FIG. 7 is a range from −67.7 degrees to +72.0 degrees. Thus, the directivity in the X-Z plane is improved.

When comparing FIG. 8 with FIG. 10, the range where the antenna device gains 2 dBi or more in FIG. 10 is a range of ±33.2 degrees, but the range where the antenna device 2 gains 2 dBi or more in FIG. 8 is a range of ±46.8 degrees. Thus, the directivity in the Y-Z plane is improved.

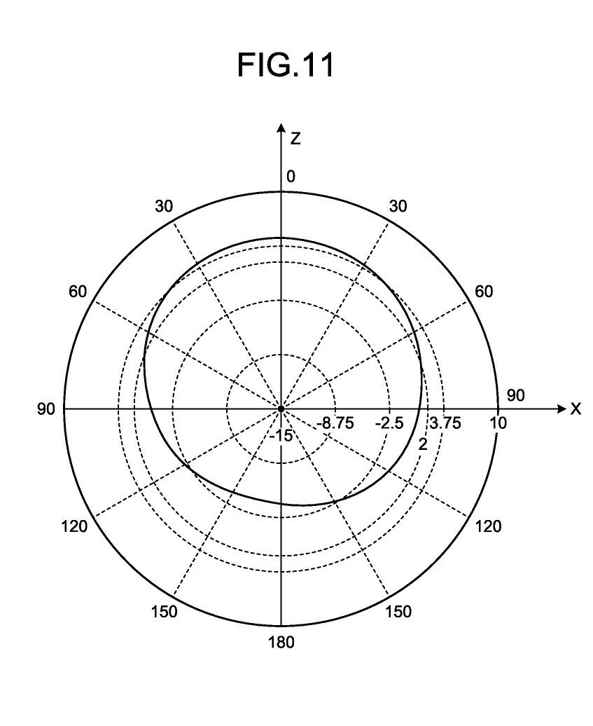

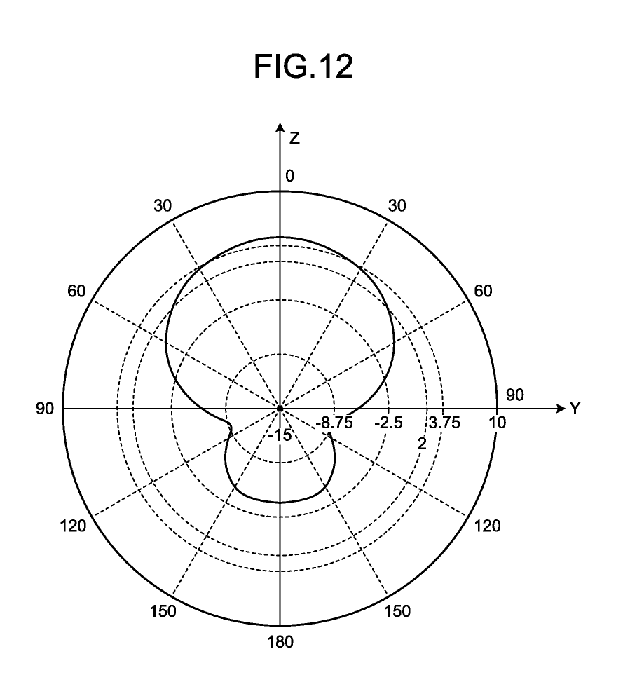

Next, another example of the radiation characteristics of the antenna device 2 according to the present embodiment will be described with reference to FIG. 11 and FIG. 12. FIG. 11 and FIG. 12 are diagrams each illustrating the radiation characteristics when a rectangular parallelepiped phantom (not illustrated) is disposed at the vicinity of the substrate 100 of the antenna device 2 according to the present embodiment. The examples in FIG. 11 and FIG. 12 illustrate the radiation characteristics of the antenna device 2, when the rectangular parallelepiped phantom is disposed at a location approximately 10 mm away from the ground layer 102 of the antenna device 2. FIG. 11 is a diagram illustrating the radiation characteristics of the antenna device 2 such as above in the X-Z plane, and FIG. 12 is a diagram illustrating the radiation characteristics of the antenna device 2 such as above in the Y-Z plane.

As illustrated in FIG. 11 and FIG. 12, similar to FIG. 7 and FIG. 8, in the radiation characteristics of the antenna device 2, the radio waves are properly transmitted in the direction parallel to the substrate 100 (X-axis direction and Y-axis direction). Moreover, the radio waves are prevented from transmitting in the direction where the substrate 100 is arranged from the linear conductive element 300 (Z-axis negative direction). Consequently, for example, even when a human body is located at the side of the substrate 100, the antenna device 2 is hardly affected by the human body.

In this manner, the antenna device 2 according to the second embodiment can obtain the same effects as those of the antenna device 1 according to the first embodiment. Furthermore, by disposing the second linear conductive element 325 inside the loop shape of the first linear conductive element 310, it is possible to further improve the radiation characteristics of the antenna device 2.

For example, when comparing the radiation characteristics of the antenna device 2 in the X-Z plane illustrated in FIG. 7 with the radiation characteristics of the antenna device 1 in the X-Z plane illustrated in FIG. 3, the gains in the Z-axis positive direction as well as in the X-axis negative direction are improved.

This is because it is assumed that the influence applied to the linear elements 311 to 315 of the first linear conductive element 310 by the second linear conductive element 325 is reduced, by disposing the second linear conductive element 325 inside the loop shape of the first linear conductive element 310.

### First Modification

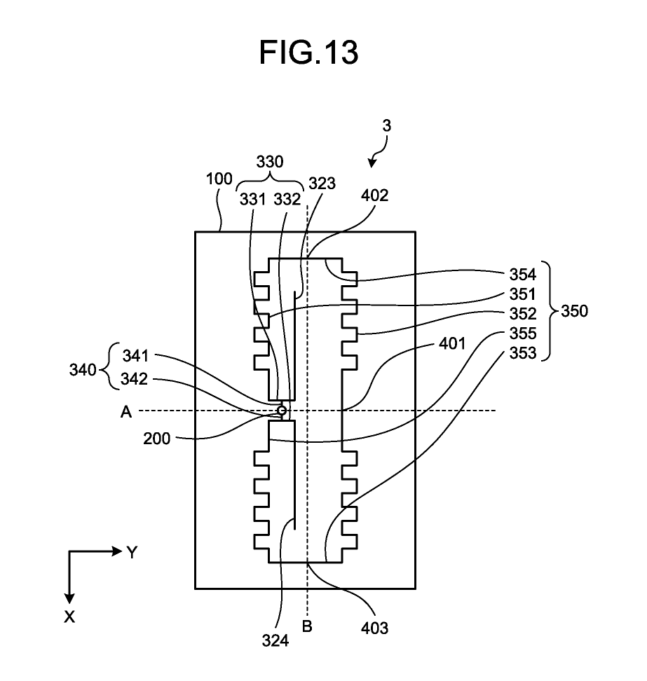

FIG. 13 is a diagram illustrating an antenna device 3 according to a first modification of the present embodiment. The antenna device 3 has the same configuration as that of the antenna device 2 according to the second embodiment, except that at least a part of a first linear conductive element 350 has a meander shape.

The first linear conductive element 350 of the antenna device 3 includes a first linear element 351 to a fifth linear element 355. The first linear element 351 and the fifth linear element 355 each have a meander shape. The second linear element 352 has a meander shape, and is disposed so as to be line-symmetric with respect to the first and the fifth linear elements 351 and 355, and the second straight line B.

The fourth linear element 354 is a straight line an end of which is connected to an end of the first linear element 351, and the other end of which is connected to an end of the second linear element 352. The third linear element 353 is a straight line an end of which is connected to an end of the fifth linear element 351, and the other end of which is connected to the other end of the second linear element 352. The third linear element 353 and the fourth linear element 354 are disposed so as to be line symmetric with respect to the first straight line A.

In the antenna device 3 according to the present modification, the first linear element 351, the second linear element 352, and the fifth linear element 355 are each formed in a meander shape. Hence, it is possible to reduce the physical length of the first linear conductive element 350, while keeping the electrical length D₁ of the first linear conductive element 350 to an integer multiple of a wavelength. Thus, it is possible to reduce the size of the first linear conductive element 350. Consequently, it is possible to reduce the size of the antenna device 3 according to the present modification.

In the present modification, the first linear element 351, the second linear element 352, and the fifth linear element 355 are each formed in a meander shape. However, the third linear element 353 and the fourth linear element 354 may also be formed in a meander shape, and the second linear conductive element 325 may also be formed in a meander shape. Moreover, at least a part of the linear conductive elements of the antenna device according to the other embodiments, which will be described later, may be formed in a meander shape.

### Second Modification

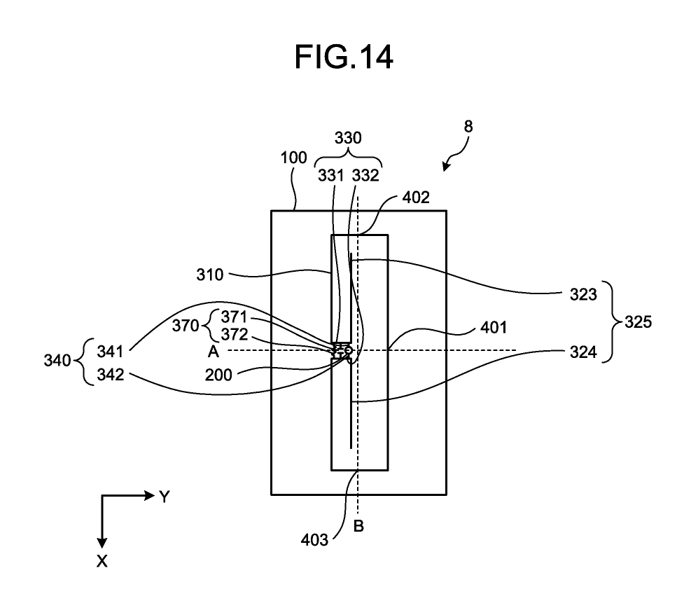

FIG. 14 is a diagram illustrating an antenna device 8 according to a second modification of the present embodiment. The antenna device 8 has the same configuration as that of the antenna device 2 according to the second embodiment, except that the antenna device 8 further includes an impedance adjustment unit 370.

The impedance adjustment unit 370 of the antenna device 8 is connected to the third linear conductive element 330 that connects between the first linear conductive element 310 and the second linear conductive element 325. The impedance adjustment unit 370 is connected to the third linear conductive element 330, and adjusts an impedance value of the first linear conductive element 310 and the second linear conductive element 320.

The impedance adjustment unit 370 includes an inductor 371 and a capacitive element 372. An end of the inductor 371 is connected to the eighth linear element 331, and the other end of the inductor 371 is connected to the ninth linear element 332. Moreover, an end of the capacitive element 372 is connected to the eighth linear element 331, and the other end of the capacitive element 372 is connected to the ninth linear element 332. In other words, the inductor 371 and the capacitive element 372 are each connected to the power feeding point 200 in parallel.

Thus, for example, even if a manufacturing error occurs during the manufacturing process of the linear conductive element 300, it is possible to easily adjust the impedance mismatch of the linear conductive element 300.

### Third Embodiment

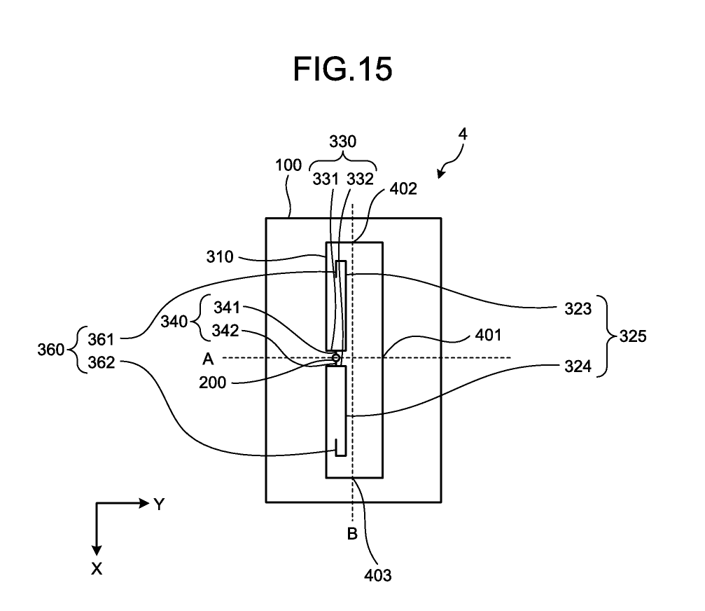

FIG. 15 is a top view illustrating a configuration of an antenna device 4 according to a third embodiment. The antenna device 4 according to the present embodiment further includes an adjustment unit 360 that adjusts a capacitor value between the first linear conductive element 310 and the second linear conductive element 325, in addition to the antenna device 2 illustrated in FIG. 5.

The adjustment unit 360 includes a first L-shaped conductive element 361 and a second L-shaped conductive element 362. One end of the first L-shaped conductive element 361 is connected to the other end of the sixth linear element 323. The first L-shaped conductive element 361 is disposed between the first linear element 311 and the sixth linear element 323.

Moreover, an end of the second L-shaped conductive element 362 is connected to the other end of the seventh linear element 324. The second L-shaped conductive element 362 is disposed between the fifth linear element 315 and the seventh linear element 324.

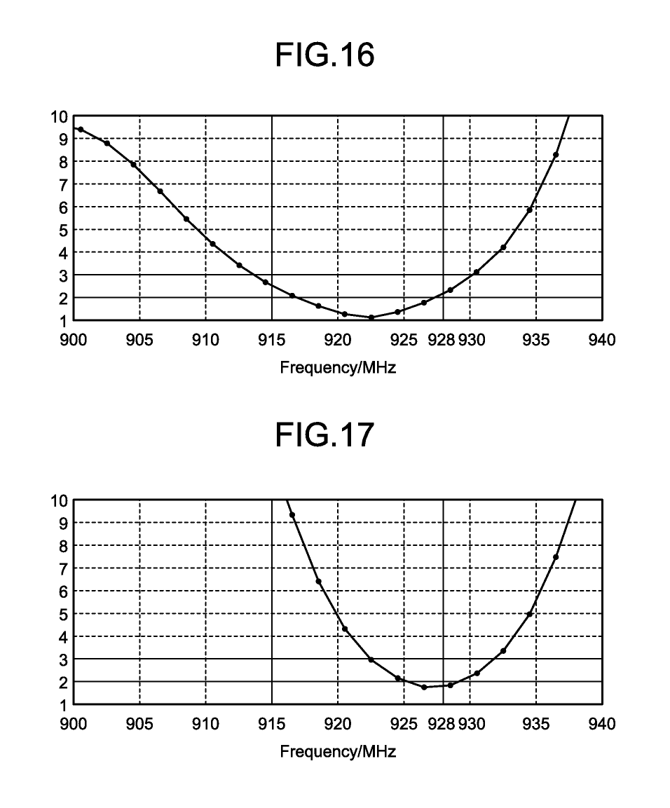

FIG. 16 is a diagram illustrating voltage standing wave ratio (VSWR) characteristics of the antenna device 4 according to the present embodiment. Moreover, FIG. 17 is a diagram illustrating the VSWR characteristics of the antenna device 2 illustrated in FIG. 5.

As illustrated in FIG. 16, the antenna device 4 according to the present embodiment has a wide frequency bandwidth where the VSWR is equal to or less than “3”. Consequently, the antenna device 4 according to the present embodiment has excellent VSWR characteristics. When comparing FIG. 16 with FIG. 17, for example, the frequency bandwidth where the VSWR is equal to or less than “2” is approximately 4 MHz in the antenna device 2, while the frequency bandwidth where the VSWR is equal to or less than “2” is approximately 10 MHz in the antenna device 4.

In this manner, the antenna device 4 according to the present embodiment can further improve the VSWR characteristics of the antenna device 2 illustrated in FIG. 5, by including the adjustment unit 360. When the VSWR characteristics are improved, it is possible to easily match the impedance of the antenna device 4, and increase the bandwidth of the antenna device 4.

In this manner, the antenna device 4 according to the third embodiment can obtain the same effects as those of the antenna device 2 according to the second embodiment, and by further including the adjustment unit 360, it is possible to easily match the impedance. Furthermore, it is possible to increase the bandwidth of the antenna device 4.

### Third Modification

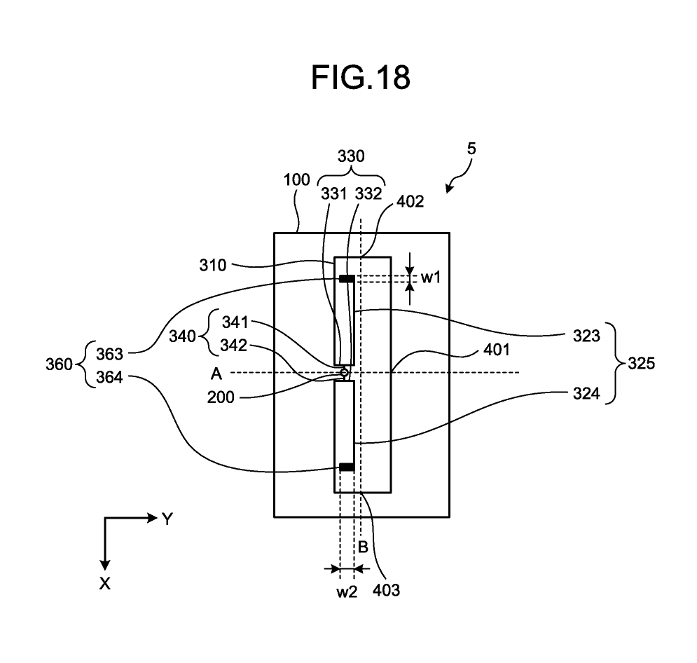

FIG. 18 is a diagram illustrating an antenna device 5 according to a third modification of the present embodiment. The antenna device 5 has the same configuration as that of the antenna device 4 according to the third embodiment, except that the adjustment unit 360 is a first plate-like element 363 and a second plate-like element 364.

The adjustment unit 360 of the antenna device 5 includes the first plate-like element 363 and the second plate-like element 364. The first plate-like element 363 and the second plate-like element 364 are rectangular conductive elements the length of which in the X-axis direction is W1, and the length of which in the Y-axis direction is W2.

One side of the first plate-like element 363 is connected to the other end of the sixth linear element 323. The first plate-like element 363 is disposed between the first linear element 311 and the sixth linear element 323.

One side of the second plate-like element 364 is connected to the other end of the seventh linear element 324. The second plate-like element 364 is disposed between the fifth linear element 315 and the seventh linear element 324.

In this manner, the adjustment unit 360 may be configured by the first plate-like element 363 and the second plate-like element 364. The plate-like elements are easy to manufacture, and the capacitor value between the first linear conductive element 310 and the second linear conductive element 325 can be easily adjusted, by adjusting the length of the sides of the plate-like elements.

### Fourth Modification

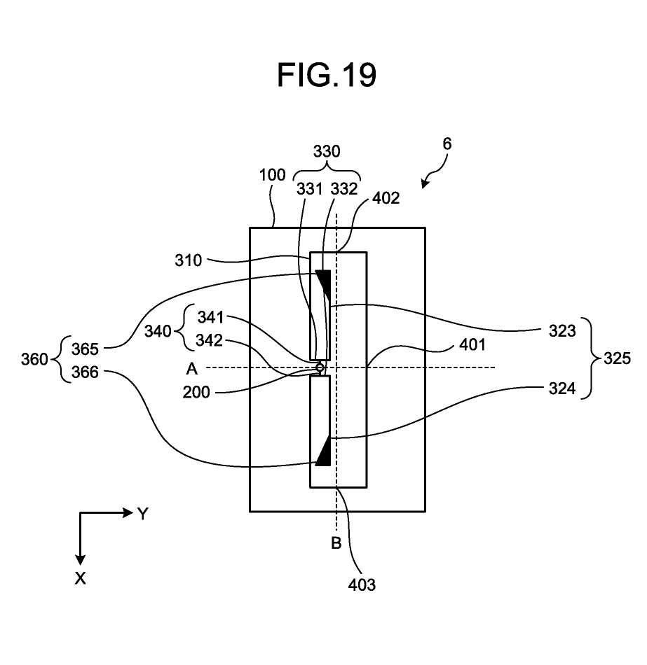

The shape of the first plate-like element 363 and the second plate-like element 364 is not limited to the rectangular shape. For example, as illustrated in FIG. 19, the shape of a first plate-like element 365 and a second plate-like element 366 may be a triangle. FIG. 19 is a diagram illustrating an antenna device 6 according to a fourth modification of the third embodiment.

As illustrated in FIG. 19, the first plate-like element 365 and the second plate-like element 366 may have a tapered shape in which the length in the Y-axis direction is increased as the first plate-like element 365 and the second plate-like element 366 are away from the power feeding point 200.

### Fifth Modification

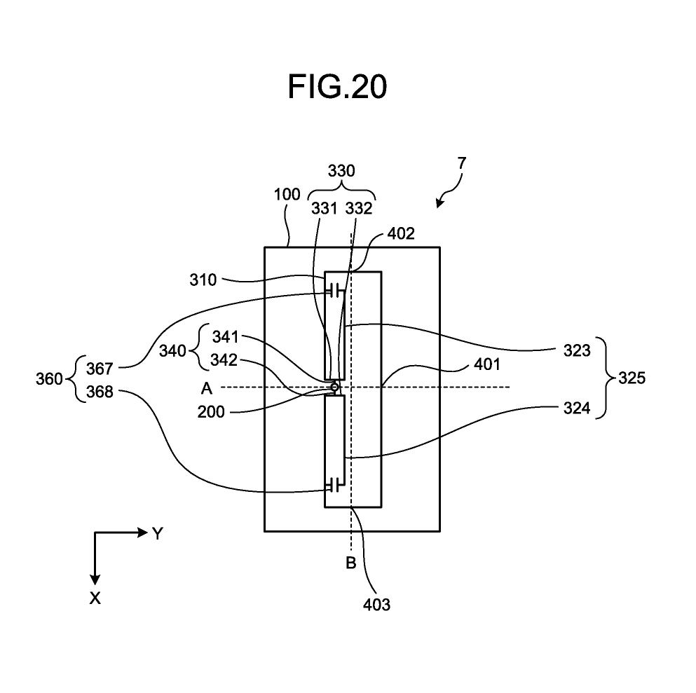

Moreover, the adjustment unit 360 is not limited to the L-shaped conductive elements 361 and 362, and the plate-like elements 363 to 366. For example, as illustrated in FIG. 20, the adjustment unit 360 may be a capacitive element. FIG. 20 is a diagram illustrating an antenna device 7 according to a fifth modification of the third embodiment.

The adjustment unit 360 of the antenna device 7 includes a first capacitive element 367 and a second capacitive element 368. One end of the first capacitive element 367 is connected to the other end of the sixth linear element 323, and the other end of the first capacitive element 367 is connected to the first linear element 311. One end of the second capacitive element 368 is connected to the other end of the seventh linear element 324, and the other end of the second capacitive element 368 is connected to the fifth linear element 315.

In this manner, the adjustment unit 360 may be configured by the first capacitive element 367 and the second capacitive element 368. Moreover, for example, by making the first capacitive element 367 and the second capacitive element 368 to be variable capacitive elements, the capacitor values of the first capacitive element 367 and the second capacitive element 368 can be adjusted according to the changes in the communication environment of the antenna device 7 and the like.

### Fourth Embodiment

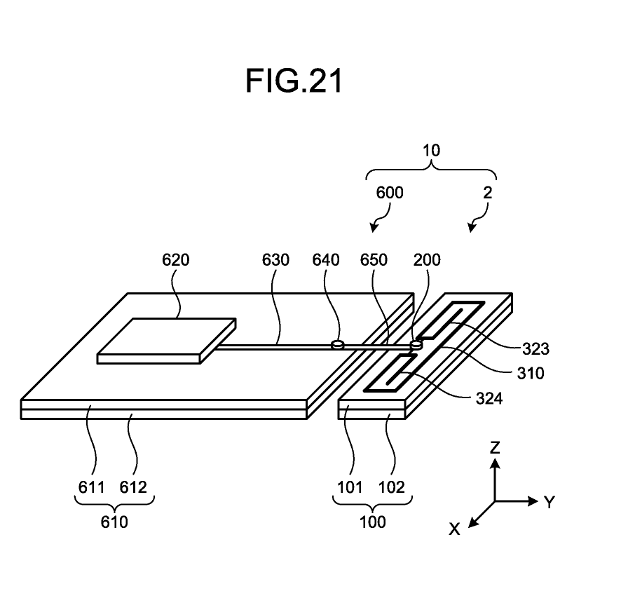

FIG. 21 is a diagram illustrating a wireless device 10 according to a fourth embodiment. The wireless device 10 according to the present embodiment is mounted with the antenna device 2 illustrated in FIG. 5. However, the wireless device 10 according to the present embodiment may also be mounted with the antenna device 1 and the antenna devices 3 to 8 that are illustrated in the other embodiments and the other modifications.

The wireless device 10 includes the antenna device 2 and a wireless unit 600 that receives or transmits a signal via the antenna device 2. The wireless unit 600 includes a substrate 610, a wireless circuit 620, a signal line 630, a terminal 640, and a power feeding line 650.

The substrate 610 includes a dielectric layer 611 and a ground layer 612. The wireless circuit 620 is provided on the dielectric layer 611 of the substrate 610. The wireless circuit 620 generates a signal, and transmits the signal via the antenna device 2. Alternatively, the wireless circuit 620 receives a signal via the antenna device 2. The signal line 630 connects between the wireless circuit 620 and the terminal 640. One end of the power feeding line 650 is connected to the terminal 640, and the other end of the power feeding line 650 is connected to the power feeding point 200.

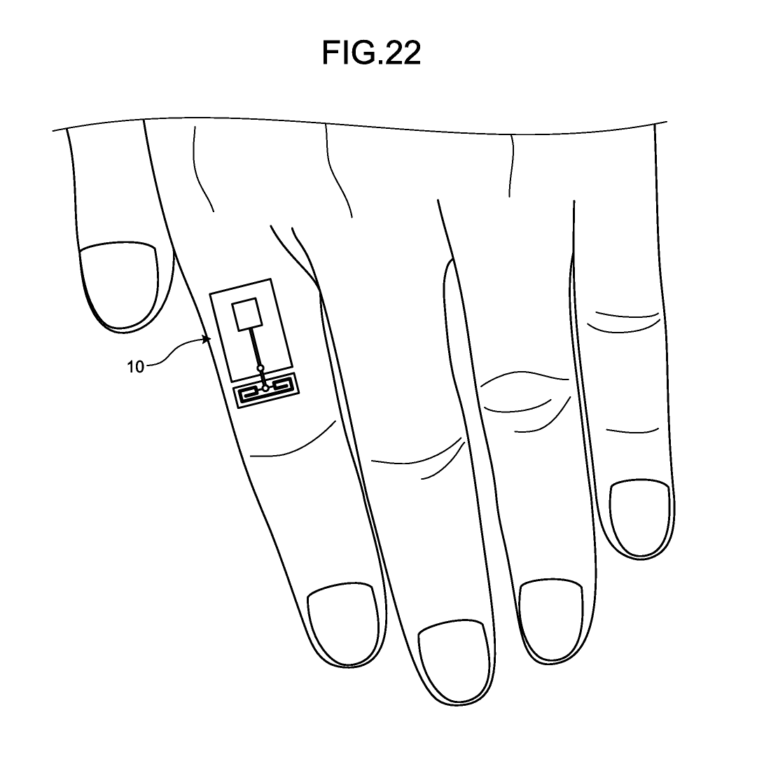

Next, an example of on-body communication by putting the wireless device 10 on a finger will be described with reference to FIG. 22. For example, the wireless device 10 may be installed in a ring (not illustrated), and the wireless device 10 is put on a finger, by wearing the ring. Alternatively, the wireless device 10 may be put on a finger using a belt.

For example, it is assumed that the wireless device 10 worn on a finger and the wireless device 10 worn on the chest (not illustrated) communicate with each other. When on-body communication is performed between the wireless devices 10 that are worn on human bodies in this manner, there are more instances in which wireless devices 10 communicate with each other on substantially the same plane compared with those of general wireless communication.

The wireless device 10 according to the present embodiment includes the antenna device 2 that can properly transmit the radio waves toward the same plane as the substrate 100. Thus, the on-body communication can be properly executed even when the wireless device 10 is worn on the human body.

In this manner, the wireless device 10 according to the present embodiment can obtain the same effects as those of the second embodiment, by communicating via the antenna device 2. Moreover, it is possible to improve communication flexibility of the wireless device 10. Furthermore, the wireless device 10 can properly communicate with the other wireless device that is arranged on the same plane, such as when the wireless device 10 is worn on the human body for the on-body communication.

In the present embodiment, the antenna device 2 transmits and receives a signal. However, the antenna device 2 may only transmit a signal, or only receive a signal.

Moreover, in the present embodiment, the antenna device 2 and the wireless unit 600 are disposed on the same plane. However, the arrangement of the antenna device 2 and the wireless unit 600 is not limited thereto. The antenna device 2 and the wireless unit 600 may be disposed on different planes.

### Sixth Modification

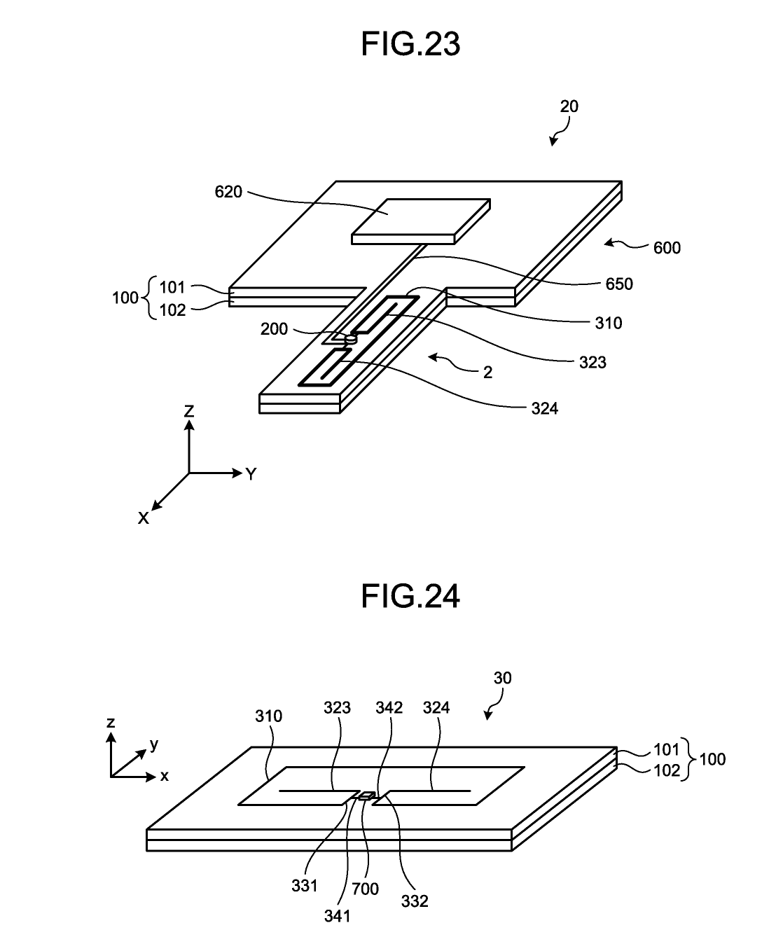

FIG. 23 is a diagram illustrating a wireless device 20 according to a sixth modification of the present embodiment. The wireless device 20 illustrated in FIG. 23 is different from the wireless device 10 in FIG. 21 in providing the wireless circuit 620 on the substrate 100 of the antenna device 2. Consequently, the wireless device 20 does not include the signal line 630 and the terminal 640, and one end of the power feeding line 650 of the wireless device 20 is connected to the wireless circuit 620, and the other end of the power feeding line 650 is connected to the power feeding point 200.

In this manner, it is possible to reduce the parts of the wireless device 20, by providing the wireless circuit 620 of the wireless device 20 on the substrate 100 of the antenna device 2.

### Seventh Modification

FIG. 24 is a diagram illustrating a wireless device 30 according to a seventh modification of the present embodiment. The wireless device 30 illustrated in FIG. 24 includes a wireless unit 700 instead of the power feeding point 200. The other components are the same as those in the antenna device 2 illustrated in FIG. 5 and are denoted by the same reference numerals, and a detailed description thereof will be omitted.

The wireless unit 700 is, for example, an integrated circuit (IC) of a radio frequency identifier (RFID) tag or a sensor IC with a wireless function. The wireless unit 700 transmits a signal via the linear conductive element 300, by inputting the signal directly to the linear conductive element 300. Alternatively, the wireless unit 700 receives a signal via the linear conductive element 300, by receiving the signal directly from the linear conductive element 300. In this manner, it can be assumed that the wireless unit 700 also operates as the power feeding point 200, by transmitting and receiving a signal directly with the linear conductive element 300.

In this manner, the antenna devices 1 to 8 of the embodiments may be provided in the wireless device 30 that is directly connected to an antenna element such as the IC of the RFID tag. Consequently, the wireless device 30 can communicate in a large angle range, and can improve communication flexibility.

While some embodiments of the present invention have been described, these embodiments are merely examples, and are not intended to limit the scope of the invention. These novel embodiments may be implemented in various other forms, and various omissions, replacements, and modifications may be made without departing from the scope and spirit of the invention. These embodiments and modifications are included in the scope and spirit of the invention, and are included in the invention described in the claims and their equivalents.

1. An antenna device, comprising:
a substrate;
a first linear conductive element that is disposed on the substrate so as to have a loop shape line-symmetric with respect to a first straight line and a second straight line that is orthogonal to the first straight line, the first linear conductive element having a first electrical length between intersections of the first linear conductive element and the second straight line that is an integer multiple of a wavelength at a resonance frequency; and
a second linear conductive element that is disposed on the substrate and is substantially parallel to the second straight line, the second linear conductive element having a second electrical length that is a half wavelength of the wavelength at the resonance frequency.

2. The antenna device according to claim 1, wherein the second linear conductive element is disposed inside the loop shape of the first linear conductive element.

3. The antenna device according to claim 1, wherein a third electrical length from an intersection between the first linear conductive element and the first straight line to an intersection between the first linear conductive element and the second straight line is an odd multiple of the half wavelength of the resonance frequency.

4. The antenna device according to claim 1, wherein the first straight line is a straight line that passes through a power feeding point that feeds power to the first linear conductive element and the second linear conductive element.

5. The antenna device according to claim 1, wherein
the first linear conductive element comprises a plurality of linear elements that are parallel to each other, and
a fourth electrical length between the linear elements is an odd multiple of the half wavelength of the resonance frequency.

6. The antenna device according to claim 1, further comprising:
a third linear conductive element that connects between the first linear conductive element and the second linear conductive element; and
an impedance adjustment element that is connected to the third linear conductive element and that is configured to adjust an impedance value of the first linear conductive element and the second linear conductive element.

7. The antenna device according to claim 1, wherein a first end and a second end of the second linear conductive element are provided with an adjustment unit configured to adjust a capacitor value between the first linear conductive element and the second linear conductive element.

8. The antenna device according to claim 7, wherein the adjustment unit comprises a conductive element having a plate shape.

9. A wireless device, comprising:
an antenna device that includes:
a substrate;
a first linear conductive element that is disposed on the substrate so as to have a loop shape line-symmetric with respect to a first straight line and a second straight line that is orthogonal to the first straight line, the first linear conductive element having a first electrical length between intersections of the first linear conductive element and the second straight line that is an integer multiple of a wavelength at a resonance frequency; and
a second linear conductive element that is disposed on the substrate and is substantially parallel to the second straight line, the second linear conductive element having a second electrical length that is a half wavelength of the wavelength at the resonance frequency; and
a wireless transceiver configured to perform wireless communication via the antenna device.

10. The wireless device according to claim 9, wherein the second linear conductive element is disposed inside the loop shape of the first linear conductive element.

11. The wireless device according to claim 9, wherein a third electrical length from an intersection between the first linear conductive element and the first straight line to an intersection between the first linear conductive element and the second straight line is an odd multiple of the half wavelength of the resonance frequency.

12. The wireless device according to claim 9, wherein the first straight line is a straight line that passes through a power feeding point that feeds power to the first linear conductive element and the second linear conductive element.

13. The wireless device according to claim 9, wherein
the first linear conductive element comprises a plurality of linear elements that are parallel to each other, and
a fourth electrical length between the linear elements is an odd multiple of the half wavelength of the resonance frequency.

14. The wireless device according to claim 9, further comprising:
a third linear conductive element that connects between the first linear conductive element and the second linear conductive element; and
an impedance adjustment element that is connected to the third linear conductive element and that is configured to adjust an impedance value of the first linear conductive element and the second linear conductive element.

15. The wireless device according to claim 9, wherein a first end and a second end of the second linear conductive element are provided with an adjustment unit configured to adjust a capacitor value between the first linear conductive element and the second linear conductive element.

16. The wireless device according to claim 15, wherein the adjustment unit comprises a conductive element having a plate shape.
